(19) United States
(12) Patent Application Publication
(10) Pub. No.: US 2024/0220708 A1
(43) Pub. Date: Jul. 4, 2024

(54) METHOD FOR DATA DISPLAY, STORAGE MEDIUM, AND ELECTRONIC DEVICE

(71) Applicant: BOE TECHNOLOGY GROUP CO., LTD., Beijing (CN)

(72) Inventor: Min ZHANG, Beijing (CN)

(73) Assignee: BOE Technology Group Co., Ltd., Beijing (CN)

(21) Appl. No.: 17/916,547

(22) PCT Filed: Aug. 31, 2021
(86) PCT No.: PCT/CN2021/115662

§ 371 Date: Sep. 30, 2022

(51) Int. Cl. G06F 40/166; G06F 3/0482; G06F 3/0484

(52) U.S. Cl. CPC G06F 40/166; G06F 3/0482; G06F 3/0484

(57) ABSTRACT

The present disclosure provides a method for data display, a storage medium and an electronic device, relating to the field of computer technology. The method includes: generating an original form item, where the original form item includes a selection control, the selection control is associated with an option list, and the option list includes at least one option data; in response to receiving a selection operation for a first option data in the option list, displaying the first option data on a user page; removing the first option data from the option list and updating the option list; in response to receiving a selection operation for a second option data in the updated option list, displaying the second option data on the user page.

### CROSS REFERENCE

The present disclosure is based upon International Application No. PCT/CN2021/115662 filed on Aug. 31, 2021, and the entire contents of which are incorporated herein by reference.

### TECHNICAL FIELD

The present disclosure relates to the field of computer technology, in particular to a method for data display, an apparatus for data display, a computer-readable storage medium, and an electronic device.

### BACKGROUND

The complexity of the function and interaction of a page increases with the constant updating of front-end technologies and frameworks. In front-end development, Vue is a progressive framework for building a user interface. Based on the Vue framework, a front-end page can be rapidly developed, such as a form component that can realize response data binding.

It should be noted that the information disclosed in the above background part is only used to enhance the understanding of the background of the disclosure, so it can include information that does not constitute the prior art known to those of ordinary shill in the art.

### SUMMARY

The present disclosure provides a method for data display, an apparatus for data display, a computer-readable storage medium, and an electronic device.

The present disclosure provides a method for data display, including:
generating an original form item, where the original form item includes a selection control, the selection control is associated with an option list, and the option list includes at least one option data;
displaying, in response to receiving a selection operation for a first option data in the option list, the first option data on a user page;
removing the first option data from the option list and updating the option list; and
displaying, in response to receiving a selection operation for a second option data in the updated option list, the second option data on the user page.

In some embodiments of the present disclosure, before generating the original form item, the method further includes:
obtaining an option array of a selection box component, where the option array includes at least one option identifier and an option content; and
assigning the option array to a first definition variable of the selection box component, where the first definition variable is used to store the option data to be selected.

In some embodiments of the present disclosure, the generating the original form item includes:
setting an attribute value of the selection box component to enable an option data in the option array to include both the option identifier and the option content;
setting an initial value of the option identifier; and
generating the original form item by rendering the user page according to the initial value of the option identifier, and displaying the option content in the selection control of the original form item.

In some embodiments of the present disclosure, the displaying, in response to receiving the selection operation for the first option data in the option list, the first option data on the user page, includes:
displaying, in response to receiving the selection operation for the first option data in the option list, the option content in the first option data in the selection control of the original form item.

In some embodiments of the present disclosure, in response to receiving the selection operation for the first option data in the option list, the method further includes:
triggering a component function used to listen to the selection control of the original form item and receiving the first option data passed in.

In some embodiments of the present disclosure, the removing the first option data from the option list and updating the option list includes:
moving the first option data from the first definition variable of the selection box component to a second definition variable of the option component using the component function, and updating the option list according to the first definition variable, where the second definition variable is used to store the option data being selected.

In some embodiments of the present disclosure, after updating the option list, the method further includes:
adding, in response to receiving an adding instruction for a form item, an option data with an option identifier of null value in the option array; and
displaying the option data on the user page and generating a new form item.

In some embodiments of the present disclosure, the displaying, in response to receiving the selection operation for the second option data in the updated option list, the second option data on the user page, includes:
displaying, in response to receiving the selection operation for the second option data in the updated option list, the option content in the second option data in a selection control of the new form item.

In some embodiments of the present disclosure, after the displaying the first option data on the user page, the method further includes:
triggering a component function used to listen to the selection control of the original form item in response to receiving a replacement operation for the first option data, and receiving a third option data passed in, where the third option data is stored in the first definition variable as the option data to be selected;
moving the third option data from the first definition variable to the second definition variable using the component function; and
displaying the option content in the moved third option data in the selection control of the original form item.

In some embodiments of the present disclosure, in response to moving the third option data from the first definition variable to the second definition variable using the component function, the method further includes:
moving the first option data from the second definition variable to the first definition variable using the component function.

In some embodiments of the present disclosure, the moving the first option data from the second definition variable to the first definition variable using the component function includes:
storing the first option data into an indefinite array according to the option identifier in the first option data;
determining a length of the indefinite array by traversing the second definition variable; and
moving the first option data from the second definition variable to the first definition variable according to the length of the indefinite array.

In some embodiments of the present disclosure, after generating the original form item, the method further includes:
moving, in response to receiving a movement instruction for a form item, according to a form item identifier included in the movement instruction, the option data in the option array corresponding to the form item identifier;
updating the option array according to the moved option data; and
displaying the updated option array on the user page.

In some embodiments of the present disclosure, after generating the original form item, the method further includes:
deleting, in response to receiving a deletion instruction for a form item, according to a form item identifier included in the deletion instruction, the option data in the option array corresponding to the form item identifier;
updating the option array according to the deleted option data; and
displaying the updated option array on the user page.

In some embodiments of the present disclosure, the method further includes:
generating a target sequence by sorting the option data selected in the option array; and outputting the target sequence to a terminal device for display to a user.

The present disclosure provides an apparatus for data display, including:
an original form item generation module, configured to generate the original form item, where the original form item includes a selection control, the selection control is associated with an option list, and the option list includes at least one option data;
a first option data display module, configured to display the first option data on a user page in response to receiving a selection operation for the first option data in the option list;
an option list updating module, configured to remove the first option data from the option list and update the option list;
a second option data display module, configured to display the second option data on the user page in response to receiving a selection operation for the second option data in the updated option list.

The present disclosure provides a computer-readable storage medium with a computer program stored on, where any one of the above methods is implemented when the computer program is executed by a processor.

The present disclosure provides an electronic device, including: a processor; and a memory, configured to store an executable instruction by the processor; where the processor is configured to execute any one of the above methods by executing the executable instruction.

It should be understood that the above general description and the following detailed description are only illustrative and explanatory, and do not limit the present disclosure.

### BRIEF DESCRIPTION OF THE DRAWINGS

The accompanying drawings, which are incorporated in and constitute a part of the description, illustrate embodiments consistent with the disclosure and together with the description serve to explain the principles of the disclosure. Obviously, the drawings in the following description are some embodiments of the present disclosure, and for those of ordinary skill in the art, other drawings can also be obtained from these drawings without creative efforts.

FIG. 1 shows a schematic diagram of an exemplary system architecture to which the method and apparatus for data display according to the embodiments of the present disclosure can be applied;

FIG. 2 schematically shows a flow chart of a method for data display according to an embodiment of the present disclosure;

FIG. 3 shows a schematic diagram of a form page according to an embodiment of the present disclosure;

FIG. 4 schematically shows a flow chart of replacing the option data in a scenic spot selection box according to an embodiment of the present disclosure;

FIG. 5 schematically shows a flowchart for displaying the replaced option data in the option list according to an embodiment of the present disclosure;

FIG. 6 shows a schematic diagram of a form page according to another embodiment of the present disclosure;

FIG. 7 schematically shows a block diagram of an apparatus for data display according to an embodiment of the present disclosure;

FIG. 8 shows a structural diagram of a computer system suitable for implementing an electronic device according to an embodiment of the present disclosure.

### DETAILED DESCRIPTION

The exemplary embodiments will now be described more fully with reference to the accompanying drawings. However, the exemplary embodiments can be implemented in a variety of forms, and should not be construed as limited to the examples set forth here. On the contrary, providing these embodiments will make the disclosure more comprehensive and complete, and comprehensively convey the concept of the exemplary embodiments to those skilled in the art. The described features, structures or characteristics may be combined in one or more embodiments in any suitable manner. In the following description, many specific details are provided to give a full understanding of the embodiments of the present disclosure. However, those skilled in the art will realize that the technical solution of the present disclosure can be practiced with omitting one or more of the specific details, or adopting other methods, components, devices, steps, etc. In other cases, the well-known technical solutions are not shown or described in detail to avoid that all aspects of the present disclosure become obscured due to distraction.

In addition, the drawings are only schematic diagrams of the present disclosure and are not necessarily drawn to scale. The same reference numerals in the drawings represent the same or similar parts, and therefore repeated description of them will be omitted. Some of the block diagrams shown in the drawings are functional entities and do not necessarily correspond to physically or logically independent entities. These functional entities may be implemented in software, or in one or more hardware modules or integrated circuits, or in different networks and/or processor devices and/or microcontroller devices.

FIG. 1 shows a schematic diagram of the system architecture of an exemplary application environment in which a method and an apparatus for data display according to the embodiments of the present disclosure can be applied.

As shown in FIG. 1, the system architecture 100 may include one or more of the terminal devices 101, 102 and 103, the network 104 and the server 105. The network 104 is a medium for providing a communication link among the terminal devices 101, 102, 103 and the server 105. The network 104 may include various connection types, such as wired communication links, wireless communication links, optical fiber cables, and the like. The terminal devices 101, 102, 103 may be various electronic devices, including but not limited to desktop computers, portable computers, smart phones, tablets, etc., for providing user interfaces for data display. It should be understood that the number of terminal devices, networks and servers in FIG. 1 is only schematic. According to the implementation requirements, it can include any number of terminal devices, networks and servers. For example, the server 105 can be a server, a server cluster composed of a plurality of servers, or a cloud computing platform or a virtualization center. In addition, the server 105 may be used to provide background services for view components and the like that support the data display. Specifically, the server 105 can be used to perform: generating an original form item, where the original form item includes a selection control, the selection control is associated with a option list, and the option list includes at least one option data; in response to receiving the selection operation for the first option data in the option list, displaying the first option data on the user page; removing the first option data from the option list and updating the option list; in response to receiving the selection operation for the second option data in the updated option list, displaying the second option data on the user page.

The method for data display provided by the embodiments of the present disclosure is generally implemented by the server 105. Accordingly, the apparatus for data display is generally set in the server 105. The server can send the option data selected by the user in turn to the terminal device, and the terminal device will display it to the user. However, it is easy for those skilled in the art to understand that the method for data display provided in the embodiments of the present disclosure can also be executed by one or more of the terminal devices 101, 102, and 103. Accordingly, the apparatus for data display can also be set in the terminal devices 101, 102, and 103. For example, after being executed by the terminal device, the option data selected by the user in turn can be directly displayed on the display screen of the terminal device, which is not specifically defined in the exemplary embodiments.

The technical solutions of the embodiments of the present disclosure are described in detail below.

The complexity of the function and interaction of a page increases with the constant updating of front-end technologies and frameworks. In front-end development, Vue is a progressive framework for building a user interface. Based on the Vue framework, a front-end page can be rapidly developed, such as a form component that can realize response data binding. Taking a selection box component in the form component as an example, component encapsulation can be carried out based on Vue-Cli framework (a scaffolding tool in Vue framework) and Element UI (a set of UI component library based on Vue framework). The number of selection boxes can be dynamically increased or decreased by using the selection box component of Element UI and the function of adding or removing form items. However, the functions implemented are not rich enough to meet the requirements of users in specific situations.

The embodiments of the present disclosure can be illustrated by taking the scene of generating a scenic spot route in a scenic area user interface according to user's requirements as an example, where, the scenic area user interface can be a user interface of a scenic area application, and the user interface can be encapsulated and rendered by the Vue-Cli framework and Element UI selection box component. If the scenic area includes a plurality of scenic area projects, each scenic area project can correspond to one scenic spot. Before entering the scenic area, users can independently design a scenic spot route in the user interface of the scenic area application. Understandably, the scenic spot route can include at least one scenic spot. For example, users can sort scenic spots according to their preference for each scenic spot and generate a corresponding scenic spot route. Specifically, the user can set each scenic spot included in the scenic spot route in the user interface, save the order of each scenic spot, and dynamically increase or decrease the number of scenic spots according to the actual situation. However, users cannot adjust the order of each scenic spot, which affects the user's experience. In addition, when the user selects the next scenic spot, the selected scenic spot will also appear in the option list, which can be selected again, so that repeated scenic spots appear in the scenic spot route, further reducing the user's experience.

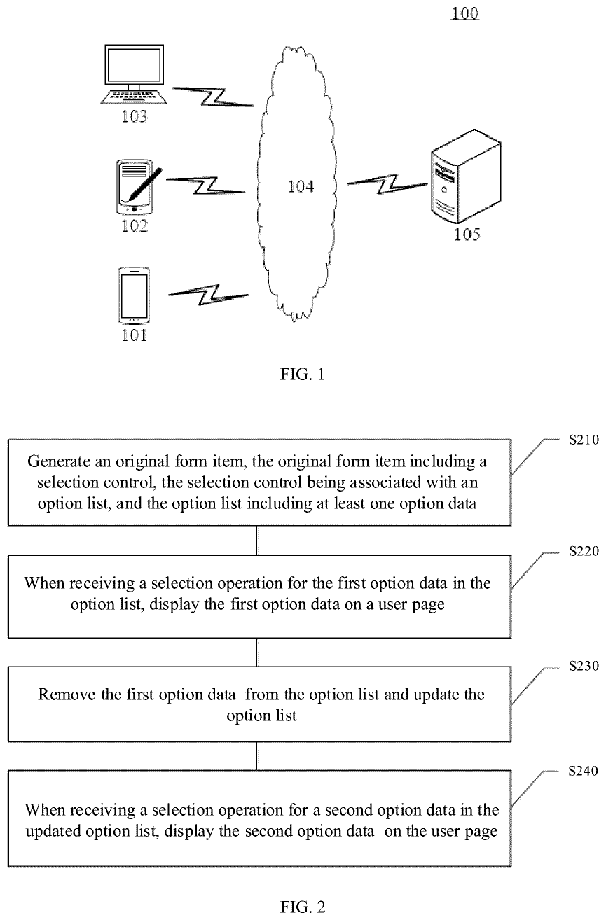

Based on the above one or more problems, the embodiments provide a method for data display, which can be applied to the above server 105, or to one or more of the above terminal devices 101, 102, 103, which is not specifically limited in the embodiments. With reference to FIG. 2, the method for data display can include the following steps S210 to S240.
In step S210, an original form item is generated, the original form item includes a selection control, the selection control is associated with an option list, and the option list includes at least one option data;
In step S220, when receiving a selection operation for the first option data in the option list, the first option data is displayed on a user page;
In step S230, the first option data is removed from the option list and the option list is updated;
In step S240, when receiving a selection operation for a second option data in the updated option list, the second option data is displayed on the user page.

In the method for data display provided in the embodiments of the present disclosure, by generating the original form item, the original form item includes a selection control, the selection control is associated with the option list, and the option list includes at least one option data; When receiving the selection operation for the first option data in the option list, the first option data is displayed on the user page; The first option data is removed from the option list and the option list is updated; When receiving the selection operation for the second option data in the updated option list, the second option data is displayed on the user page. The present disclosure can remove the selected option data from the option list, and realizes dynamic form items with no repeated selected values.

The selection box component in the embodiments of the present disclosure can have the characteristics of dynamic changes in the selection box options and non-repeated selected values. First, the component parameters of the selection box component may be described, where, the component parameters of v-model/value, options, and label-In-value are mainly described.
1. v-model/value. In Vue framework, a v-model may be used to create bidirectional data binding on form elements, value is a bidirectional binding value of the form, and a plurality of value can form an option value array [{value} ]. Where, v-model is the bidirectional binding instruction in Vue framework. For example, when an input control on the user interface is bidirectional bond with a value attribute, the value of the input control on the user interface can be synchronously updated to the bound value attribute, or the value of the input control on the user interface may be updated when updating the bound value attribute. The bidirectional binding variables used by the form items in Vue framework can store and synchronize the values of the form items, and are used to return the values of all form items in dynamic form items.
2. options. It is a required parameter, representing the selection box option array, such as [{value, label} ]. Where, value is the selected value of the selection box, representing the unique identifier of the selection box option, such as number, label can represent the option content of the selection box. Users can see the value of label but not the value of value on the user interface. For example, when users use the selection box component to select scenic spots, for the option array [{value: 1, label: Scenic Spot 1}, {value: 2, label: Scenic Spot 2} ], users can see that the option list includes two options of “Scenic Spot 1” and “Scenic Spot 2” on the user interface. It can be understood that the selected value of the corresponding selection box is “1” when the user selects “Scenic Spot 1”, and the selected value of the corresponding selection box is “2” when the user selects “Scenic Spot 2”.
3. label-In-value. It is an optional parameter, indicating whether to pack the value of label of each option into the value of value or not. The data type of the attribute value is Boolean, and the default attribute value is false, indicating that the selected value in the selection box is the value of value of the option by default. For example, when the user selects “Scenic Spot 1”, the selected value of the corresponding selection box is “1”. If the selected value in the selection box needs to include both the value of value and the value of label of the option, the attribute value of label-In-value can be set to true. For example, when the user selects “Scenic Spot 1”, the returned selected value of the selection box is “1—Scenic Spot 1”.

Next, the above steps of the embodiments of the present disclosure will be described in more detail.

In step S210, an original form item is generated. The original form item includes a selection control, the selection control is associated with an option list, and the option list includes at least one option data.

In some embodiments of the present disclosure, Vue-Cli framework and Element UI can be used to encapsulate commonly used form function modules or components in advance. For example, a dynamic selection box component can be obtained by encapsulating a function module for adding or removing form items and a selection box component. By initializing the selection box component, the original form item can be generated on the user interface. The original form item can include but are not limited to a selection control, a button control, etc. Among them, the selection control can be a drop-down selection box, radio selection box, multiple selection box, etc., and the button control can be a Move-up button, a Move-down button, an Add button, a Delete button, etc. The selection control can also be associated with the option list, which can include at least one option data.

Before initializing the selection box component to generate the original form item, the option data displayed to the user may be obtained first, such as scenic spot data. Exemplary, the option data can be obtained from the server through a network request. The option data can be an array of objects to be displayed. The object array can include the object information of each object and the object identifier corresponding to the object information. The object identifier can be used as the option identifier, and the object information can be used as the option content. The option array of the selection box component is composed of the option identifier and the option content, and the option array is assigned to the first definition variable of the selection box component. The first definition variable can be used to store the option data to be selected.

For example, the obtained option data can be a scenic spot array, which is an object array. Each object stores a scenic spot information and an id that can be used to uniquely identify the scenic spot. Among them, the scenic spot information can include scenic spot name, scenic spot location and the like. Then the scenic spot name can be filtered out from the scenic spot information, and id of the scenic spot can be taken as the value of the value attribute, and the scenic spot name can be taken as the value of the label attribute. Based on this, an option object {value, label} can be generated for each scenic spot. A plurality of option objects can form an option array [{value, label} ]. The option array can be used as the value of the parameter options of the selection box component. At the same time, the option array can also be assigned to the first definition variable of the selection box component. The first definition variable can be an unselected option array (optionsShow), which is used to store the unselected option data in the parameter options, and can be used to generate the option content of the selection box in each form item. optionsShow corresponds to the option list of the user interface, but the user can only see the value of label in the option list. It should be noted that the second definition variable of the selection box component can be a selected option array (optionsSelect), which is used to store the selected option data in the parameter options. In this example, the object array obtained from the server is processed to obtain the option array. The option array is visualized through the selection box component to display the option data to the user on the terminal device.

After obtaining the option data, the selection box component parameters can be set to initialize the selection box component. Specifically, the attribute value of the selection box component can be set so that the option data in the option array includes both the option identifier and the option content. The initial value of the option identifier can also be set, the user page can be rendered according to the initial value of the option identifier to generate the original form item, and the option content can be displayed in the selection control of the original form item. For example, the attribute value of label-In-value can be set to true, so that the selected value of the selection box includes both the value of value and the value of label of the option. The v-model is bound to the form variable (form.spots) of the current page, and the initial value of form.spots is set to [“], which represents that the initialized form includes a form item and the option content of the selection box is empty. It should be noted that” “ ” in the form variable is a value of value, and different values of value can correspond to different form items. It can be understood that if the initial value of form.spots is set to [“,”], which represents that the initialized form includes two form items, and the option content of the selection box are both empty. Similarly, by setting the initial value of form.spots, the initialized form can include several form items. Users can select a plurality of option data on the user interface without adding additional form items manually, which can further improve the user's operation efficiency while meeting the user's requirements.

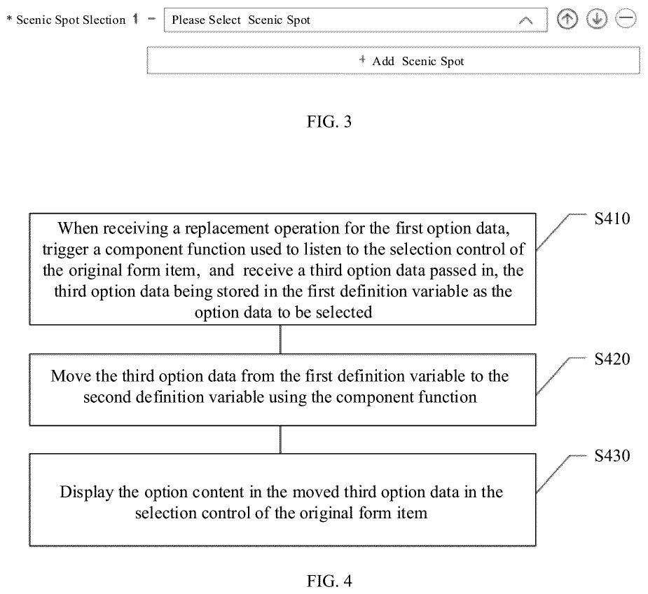

In some embodiments, the initialized selection box component can generate a dynamic form item of “Scenic Spot Selection” in the scenic area user interface. The dynamic form item can be used to set one or more scenic spots, so as to generate a scenic spot route according to the plurality of scenic spots selected by the user. Referring to FIG. 3, a schematic diagram of a form page generated by the initialized selection box component is shown. Among them, “Scenic Spot Selection” is a dynamic form item. Each line represents a form item, which can include the serial number, a scenic spot selection box, a Move-up button, a Move-down button, and a Delete button. When the user clicks the scenic spot selection box, an option list can be displayed on the form page. The option list can include a plurality of scenic spots for the user to select.

In step S220, when receiving the selection operation for the first option data in the option list, the first option data is displayed on the user page.

When selecting a scenic spot, the user can click to select the first option data in the option list as an input of the selection box. Among them, the first option data includes the first option identifier and the corresponding option content, but only the option content (the value of label) is displayed on the user interface, so the user cannot see the option identifier (the value of value). Specifically, when receiving the selection operation for the first option data, the server can display the option content in the first option data in the scenic spot selection box of the original form item. For example, the option list includes a plurality of scenic spots such as Scenic Spot 1 and Scenic Spot 2. When the user selects “Scenic Spot 1” as the input of the scenic spot selection box, the selected value of the corresponding selection box is “1-Scenic Spot 1”, and the value “1” of value is bidirectionally bound to the scenic spot selection box, which can change the display content of the scenic spot selection box to “Scenic Spot 1”. It should be noted that before the user selects a scenic spot, the option object {1, Scenic Spot 1} corresponding to the first option data, such as “Scenic Spot 1”, is stored in optionsShow as unselected option data.

In some examples, when receiving the selection operation for the first option data in the option list, a component function used to listen to the selection control of the original form item can also be triggered, and the incoming first option data can be received. The component function can be an onChange function. After the onchange function is configured for the selection box component, the onchange function can be automatically triggered and executed when the display content of the selection box changes due to the user's selection operation. For example, if the user selects “Scenic Spot 1” as the input of the selection box, the onchange function can be triggered when the display content of the scenic spot selection box changes from “empty” to “Scenic Spot 1”, and the corresponding selected value “1—Scenic Spot 1” of scenic spot is passed in.

In step S230, the first option data is removed from the option list and the option list is updated.

After the onchange function is triggered, to achieve a dynamic form item with no repeated selected values, that is the selected option data no longer appears in the option list, the onchange function can be used to move the first option data from the first definition variable of the selection box component to the second definition variable of the option component, and update the option list according to the first definition variable. For example, after the user selects “Scenic Spot 1” as the first scenic spot, the onchange function can be used to remove the option object {1, Scenic Spot 1} from optionsShow and move it to optionsSelect. Then, the option list can be updated based on the remaining unselected option data in optionsShow. The selected scenic spots can be removed from the option list by using the selection box component, avoiding users from repeatedly selecting a same scenic spot and generating a wrong scenic spot route, which improves the user's experience.

In some examples, if the initialized form includes only one form item, when the option content of the form item selection box changes from “empty” to “Scenic Spot 1”, the corresponding form.Spots changes from [″] to [1], and the user needs to generate a scenic spot route that includes a plurality of scenic spots. At this time, a function for adding a new form item (add function) of the selection box component can be used to generate a new form item. Specifically, when receiving an adding instruction for the form item, the option data with an option identifier of null can be added in the option array, and the added option data can be displayed on the user page through bidirectional binding of the form to generate a new form item. For example, as shown in FIG. 3, the dynamic form item can also include an Add button. After “Scenic Spot 1” is selected as the first scenic spot, the user can click the add button to add a null value to the bidirectional binding values of the form (i.e. the option value array), that is, form. Spots is set to [1, ″], and the null value can be automatically displayed as a new form item by Vue instruction.

In step S240, when receiving a selection operation for a second option data in the updated option list, the second option data is displayed on the user page.

After the user selects “Scenic Spot 1” as the first scenic spot, “Scenic Spot 1” will not be included in the updated option list. When selecting the second scenic spot, the user can click to select a second option data in the option list as the input of the selection box. When receiving the selection operation for the second option data, the server can display the option content in the second option data in a selection box of a new form item. It can be understood that after the user selects “Scenic Spot 2”, the onchange function can also be used to remove the option object {2, Scenic Spot 2} from optionsShow and move it to optionsSelect. The user can synchronously see that “Scenic Spot 2” is no longer included in the current option list. In the embodiments of the present disclosure, the selected scenic spots can be removed from the option list by using the selection box component, avoiding users from repeatedly selecting a same scenic spot to generate a wrong scenic spot route, and improving the user experience.

In some embodiments, referring to FIG. 4, the option data in the scenic spot selection box can be replaced according to steps S410 to S430.

In step S410, when receiving a replacement operation for the first option data, a component function used to listen to the selection control of the original form item is triggered, a third option data passed in is received, and the third option data is stored in the first definition variable as the option data to be selected.

Among them, the component function can be an onChange function. For example, the current display content of the scenic spot selection box in the original form item is “Scenic Spot 1”, that is, “Scenic Spot 1” is the first scenic spot selected by the user, i.e. the first option data. The current display content of the scenic spot selection box in the new form item is “Scenic Spot 2”, and “Scenic Spot 2” is the second scenic spot selected by the user, i.e. the second option data. According to the bidirectional binding function of Vue framework, the option value array bond to v-model is [1,2]. When the user needs to use “Scenic Spot 3” as the first scenic spot, corresponding, it is needed to replace “Scenic Spot 1” in the original form item with “Scenic Spot 3”, which is the third option data. For example, the user can select “Scenic Spot 3” as the input of the scenic spot selection box in the original form item. When the display content of the scenic spot selection box changes from “Scenic Spot 1” to “Scenic Spot 3”, the onchange function can be triggered and the corresponding selected value “3—Scenic Spot 3” of scenic spot can be passed in. Before receiving the user's replacement operation for “Scenic Spot 1”, the option object {3, Scenic Spot 3} corresponding to the selected value “3—Scenic Spot 3” of scenic spot is stored in optionsShow as the option data to be selected.

In step S420, the third option data is moved from the first definition variable to the second definition variable using the component function.

After the user selects “Scenic Spot 3” as the first scenic spot, the onchange function can be used to remove the option object corresponding to “Scenic Spot 3” from optionsShow and move it to optionsSelect. For example, if the attribute value of label-In-Value is false, the option object {3, Scenic Spot 3} with the value “3” of value can be searched from optionsShow. If the attribute value of label-In-Value is true, the option object {3, Scenic Spot 3} with value-label value of “3-Scenic Spot 3” can be searched from optionsShow. After determining the option object, the option object can be removed from optionsShow and added to optionsSelect. Similarly, since “Scenic Spot 2” is the second scenic spot selected by the user, optionsSelect changes from [{1, Scenic Spot 1}, {2, Scenic Spot 2}] to [{2, Scenic Spot 2}, {3, Scenic Spot 3}]. The selected scenic spots are removed from the option list using the selection box component, avoiding the use from repeatedly selecting a same scenic spot and generating a wrong scenic spot route, thus improving the user's experience.

In step S430, the option content in the moved third option data is displayed in the selection control of the original form item.

optionsShow can be used to store the unselected option data in the parameter options. All unselected option data corresponds to the option data in the option list one by one. Therefore, it can also be used to generate the option content of the selection box in each form item. When the user replaces “Scenic Spot 1” with “Scenic Spot 3”, the option value array bonded to v-modal changes to [2, 3], “3—Scenic Spot 3” can be displayed in the scenic spot selection box of the original form item through bidirectional binding of the form, and the content displayed in the scenic spot selection box is “Scenic Spot 3”.

In some embodiments, after replacing the first option data, the component function can also be used to move the first option data from the second definition variable to the first definition variable. For example, when the user replaces “Scenic Spot 1” with “Scenic Spot 3”, the onchange function can be used to remove the option object {1, Scenic Spot 1} from optionsSelect and move it to optionsShow. Then, the option list can be updated according to the unselected option data stored in optionsShow, so that the replaced option data can be displayed in the option list again. Therefore, the updated option list includes the unselected option “Scenic Spot 1”, but does not include the selected options “Scenic Spot 2” and “Scenic Spot 3”.

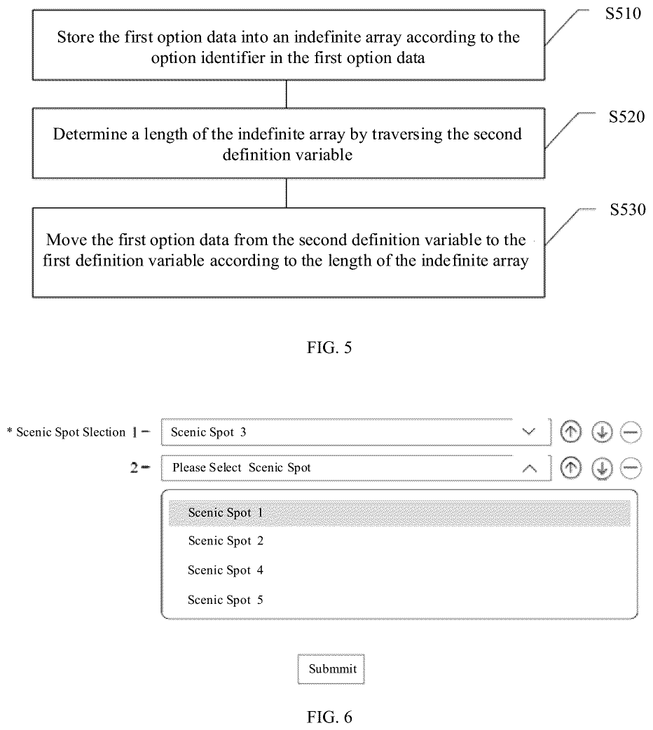

With reference to FIG. 5, the replaced option data can be re-displayed in the option list according to steps S510 to S530.

In step S510, the first option data is stored into an indefinite array according to the option identifier in the first option data;

As an example, when the user replaces “Scenic Spot 1” with “Scenic Spot 3”, that is, when the option of the scenic spot selection box of the original form item changes from “Scenic Spot 1” to “Scenic Spot 3”, the selected value “3-Scenic Spot 3” of scenic spot corresponding to “Scenic Spot 3” is passed in. The option object {3, Scenic Spot 3} with value-label of “3—Scenic Spot 3” in the attribute values can be searched from optionsShow, and the option object can be moved from optionsShow to optionsSelect.

Assume that the form variable bound to the v-model is values, due to Vue bidirectional binding function, values can be automatically synchronized with the real-time selected value of the form, that is, the old selected value can be automatically replaced with the new selected value. For an option data in optionsSelect, it can be assumed that the selected value obtained from the option data according to the attribute label-In-Value is value. If values do not include value, it can be determined that the option data is the replaced option, and the option data is put into an array rest, which can be used to store redundant option data.

For example, first of all, the user selects “Scenic Spot 1” and “Scenic Spot 2”. Correspondingly, optionsSelect is [{1, Scenic Spot 1}, {2, Scenic Spot 2}], the form variable values bound to v-model is [1, 2], and it is assumed that the attribute value of label-In-Value is false. Based on this, when the user replaces “Scenic Spot 1” with “Scenic Spot 3”, the form variable values bound to v-model can automatically change from [1, 2] to [2, 3]. At this time, for the option data “Scenic Spot 1” in optionsSelect, the selected value of value corresponding to “Scenic Spot 1” is “1”, and values are [2, 3]. It can be seen that values [2, 3] does not include value “1”, which means that the option data “Scenic Spot 1” is the replaced option, and the option object {1, Scenic Spot 1} corresponding to “Scenic Spot 1” is put into the array rest. For the option data “Scenic Spot 2” in optionsSelect, the selected value of value corresponding to “Scenic Spot 2” is “2”. It can be seen that values [2, 3] include value “2”, which means that the option data “Scenic Spot 2” is not the replaced option. At this time, it is not necessary to put the option object {2, Scenic Spot 2} corresponding to “Scenic Spot 2” into the array rest.

In step S520, a length of the indefinite array is determined by traversing the second definition variable.

When the user selects “Scenic Spot 1” and “Scenic Spot 2” in turn, optionsSelect is [{1, Scenic Spot 1}, {2, Scenic Spot 2}]. When receiving the user's third selection operation, the length of the array rest can be determined by traversing optionsSelect. For example, according to step S510, if the user's third selection operation is to replace “Scenic Spot 1” with “Scenic Spot 3”, the array rest includes the option object {1 and Scenic Spot 1} corresponding to “Scenic Spot 1”, that is, the length of the array rest is 1. If the user's third selection operation is to replace “null value” with “Scenic Spot 3” in the scenic spot selection box of the new form item, the array rest does not include any option data, that is, the length of the array rest is 0.

In step S530, the first option data is moved from the second definition variable to the first definition variable according to the length of the indefinite array.

If the length of the array rest is 0, it can indicate that the replaced display content of the scenic spot selection box has changed from a null value to a selected value of scenic spot, no other operations are required, that is, the replaced option data does not need to be moved from optionsSelect to optionsShow. If the length of the array rest is not 0, it can indicate that the replaced display content of the selection box switches from an old selected value of scenic spot to a new selected value of scenic spot. At this point, the option object in the array rest is needed to be moved to optionsShow as an optional option, and the option object can be removed from optionsSelect. Referring to the example in step S520, when the length of the array rest is 1, it means that “Scenic Spot 1” has been replaced by “Scenic Spot 3”, the option object {1, Scenic Spot 1} corresponding to “Scenic Spot 1” can be moved from the array rest to optionsShow as an optional option, so as to be displayed in the option list again, and the option object can be removed from optionsSelect.

In some embodiments, if the form includes a plurality of form items, the user needs to adjust the order of the selected scenic spots. At this time, the Move-up/Move-down function of the selection box component can be used to move the form items to be adjusted. Specifically, when receiving a movement instruction for the form item, the option data corresponding to the form item identifier in the option array is moved according to the form item identifier included in the movement instruction, and the option array is updated according to the moved option data, and then the updated option array can be displayed on the user page through bidirectional binding of the form. For example, as shown in FIG. 3, when the user clicks the Move Up button, the subscript index of the current form item can be passed in (sorted from 0), and the bidirectional binding value of the form, that is, the index item in the option value array, can be interchanged with the index+1 item to move the current form item (i.e. the index 1 item) upward. When the user clicks the Move Down button, the subscript index of the current form item can be passed in, and the value of the index+1 item in the option value array can be exchanged with the value of the index+2 item to move the current form item (i.e. the index+1 item) downward. After the option value array is updated, Vue instruction will automatically render the user interface according to the new option value array to complete moving up or down of the form item.

In some embodiments, if the form includes a plurality of form items, and the user needs to delete redundant form items, at this time, a function for deleting a form item function (delete function) of the selection box component can be used to delete the form item. Specifically, when a deletion instruction for the form item is received, the option data corresponding to the form item identifier in the option array is deleted according to the form item identifier included in the deletion instruction, the option array is updated according to the deleted option data, and then the updated option array can be displayed on the user page through bidirectional binding of the form. For example, as shown in FIG. 3, when the user clicks the Delete button, the subscript index of the current form item can be passed in (sorted from 0), and the data with the subscript index in the option value array can be deleted. After the option value array is updated, Vue instruction will automatically render the user interface according to the new option value array to complete the deletion of the form item.

In addition, when editing a scenic spot route by the user, the existing scenic spots in the route needs to be echoed by the form. For the existing scenic spots in the scenic spot route, the echo function of the selection box component can be uses to move the option objects corresponding to the selected values of all scenic spots out of optionsShow and into optionsSelect.

In some embodiments of the present disclosure, the selection box component based on Element (JI and the dynamic selection box component obtained by the function of adding or removing form items can be used to implement the selection box form items that do not allow the selection of repeated values, or to implement the selection box form items that need to return the option order and can adjust the option order, or to dynamically increase or decrease the number of form items. Each time an option is selected, the component can remove the selected option from the option list. The component can also restore the replaced old option to the option list for user selection.

In some embodiments, referring to FIG. 3, the user can click “Add Scenic Spot” to add a form item, click the Move Up button of the form item to move the form item up one line, click the Move Down button of the form item to move the form item down one line, and click the Delete button to delete the form item. It can be understood that when a plurality of form items in a form page are sorted from top to bottom, the first form item cannot be moved up and the last form item cannot be moved down. When the form page includes only one form item, the form item cannot be deleted. If the form item cannot be moved up, down or deleted, a prompt message will pop up when clicking the corresponding button. For example, if the form item is the first form item, when the user clicks the Move Up button of the form item, “It is already the first one” will be displayed on the form page responding to the click operation. If the form item is the last form item, when the user clicks the Move Down button of the form item, “It is the last one” will be displayed on the form page responding to the click operation. If there is only one form item in the form page, when the user clicks the Delete button of the form item, “At least one scenic spot needs to be selected” will be displayed on the form page responding to the click operation. In addition, repeated scenic spots are not allowed in a scenic spot route. When a user selects scenic spots, all selected scenic spots will not appear in the selection list as unselected options.

In some embodiments, the selected option data in the option array can be sorted to generate a target order. The target order can be output to a terminal device for display to the user. For example, after selecting a plurality of scenic spots, the user can click a “Submit” button to create a scenic spot route. At this time, all the selected values of scenic spots have been saved in the option value array, and the order of each scenic spot corresponds to the order of each selected value of scenic spot in the array. If the attribute value of label-In-Value is set to true, the selected value of scenic spot in the option value array can be in the form of [value1-label1, value2-label2]. The format of the value for passing of the scenic spot data in the network request can be [{spotId, spotName, order} ], where spotId can be the unique identifier id of the scenic spot, corresponding to the value attribute of the option; spotName can be the name of the scenic spot, corresponding to the label attribute of the option; order is the order of the scenic spots, corresponding to the subscript of the option array. For example, the first selected value “value 1-label1” of the scenic spot can be converted to {spotId: value 1, spotName: label1, order: 0}. After the form conversion of each selected value of scenic spot in the option value array is completed, it can be passed to the network request provided by the server to complete the route addition. After the route is added, the route of target scenic spots can be generated according to the order of scenic spots, and the route of target scenic spots can be output to the terminal device for display to the user.

In some embodiments, referring to FIG. 6, a schematic diagram of the user selecting a scenic spot is shown. After the scenic spot selection form is initialized, a scenic spot selection form item can be generated. The display content of the scenic spot selection box in the form item is null. The scenic spot selection box is associated with the option list, which includes five scenic spots in total: Scenic Spot 1, Scenic Spot 2 . . . Scenic Spot 5. When the user selects Scenic Spot 3 as the first scenic spot in the scenic spot route, the display content of the scenic spot selection box changes to be Scenic Spot 3. The user can click the “Add Scenic Spot” button to generate a new scenic spot selection form item, and the display content of the scenic spot selection box in the form item is also null. It should be noted that the “Add Scenic Spot” button is not shown in FIG. 6, which can be referred to FIG. 3. It can be seen from FIG. 6 that when the user selects a second scenic spot in the scenic spot route, the optional scenic spots in the option list change to be four scenic spots in total: Scenic Spot 1, Scenic Spot 2, Scenic Spot 4 and Scenic Spot 5. For example, the user selects Scenic Spot 1 as the second scenic spot in the scenic spot route, and then a new scenic spot form item can be added to select the remaining three scenic spots in turn. After adding scenic spots, the order of each scenic spot can be: Scenic Spot 3-Scenic Spot 1-Scenic Spot 2-Scenic Spot 5-Scenic Spot 4. Based on this, the user can also adjust the order of each scenic spot according to actual needs, and can delete the selected scenic spots. After confirming each selected scenic spot and its order, the user can click the “Submit” button to generate the final scenic spot route according to each selected scenic spot and the corresponding scenic spot order.

In the method for data display provided in the embodiments of the present disclosure, by generating an original form item, the original form item includes a selection control, the selection control is associated with an option list, and the option list includes at least one option data; When receiving a selection operation for the first option data in the option list, the first option data is displayed on the user page; The first option data is removed from the option list and the option list is updated; When receiving a selection operation for the second option data in the updated option list, the second option data will be displayed on the user page. The selected option data can be moved out of the option list in the present disclosure, and dynamic form items with no repeated selected values can be realized.

It should be noted that although the steps of the method in the present disclosure are described in the drawings in a specific order, it does not require or imply that these steps must be performed in that specific order, or that all the steps shown must be performed to achieve the desired results. Additionally or optionally, some steps can be omitted, multiple steps can be merged into one step for execution, and/or one step can be decomposed into multiple steps for execution.

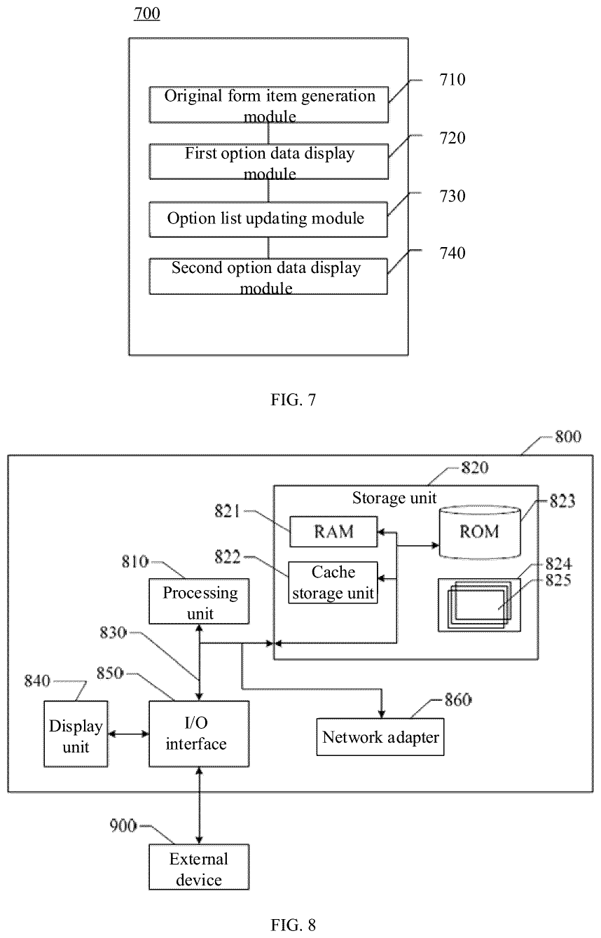

Further, there is also provided an apparatus for data display according to some embodiments of the present disclosure. The device can be applied to a server or a terminal device. With reference to FIG. 7, the apparatus 700 for data display may include an original form item generation module 710, a first option data display module 720, an option list updating module 730, and a second option data display module 740, where:
the original form item generation module 710 is configured to generate the original form item. The original form item includes a selection control, the selection control is associated with an option list, and the option list includes at least one option data;
the first option data display module 720 is configured to display the first option data on a user page when receiving a selection operation for the first option data in the option list;
the option list updating module 730 is configured to remove the first option data from the option list and update the option list;
the second option data display module 740 is configured to display the second option data on the user page when receiving a selection operation for the second option data in the updated option list.

In some embodiments, the apparatus 700 for data display further includes:
an option array acquisition module, configured to obtain the option array of the selection box component, where the option array includes at least one option identifier and option content;
a definition variable generation module, configured to assign the option array to a first definition variable of the selection box component, a where the first definition variable is used to store the option data to be selected.

In some embodiments, the original form item generation module 710 includes:
a first setting unit, configured to set the attribute value of the selection box component so that the option data in the option array includes both the option identifier and the option content;
a second setting unit, configured to set the initial value of the option identifier;
an original form item generation unit, configured to generate the original form item by rendering the user page according to the initial value of the option identifier, and display the option content in the selection control of the original form item.

In some embodiments, the first option data display module 720 includes:
a first option data display unit, configured to display the option content in the first option data in the selection control of the original form item when receiving the selection operation for the first option data in the option list.

In some embodiments, the first option data display module 720 further includes:
a first component function triggering unit, configured to trigger the component function used to listen to the selection control of the original form item and receive the first option data passed in.

In some embodiments, the option list updating module 730 includes:
a first option data movement unit, configured to move the first option data from the first definition variable of the selection box component to a second definition variable of the option component using the component function, where the second definition variable is used to store the selected option data;
an option list updating unit, configured to update the option list according to the first definition variable, and to update the option list according to the second definition variable. In some embodiments, the apparatus 700 for data display further includes:
a new form item adding module, configured to add an option data with an option identifier of null value in the option array when receiving an adding instruction for the form item;
a new form item generation module, configured to display the option data on the user page to generate a new form item.

In some embodiments, the second option data display module 740 includes:
a second option data display unit, configured to display the option content in the second option data in the selection control of the new form item when receiving the selection operation for the second option data in the updated option list.

In some embodiments, the apparatus 700 for data display further includes:
an option data replacement module, configured to trigger a component function to listen to the selection control of the original form item when receiving a replacement operation for the first option data, and receive the third option data passed in, where the third option data is stored in the first definition variable as the option data to be selected;
a third option data movement module, configured to move the third option data from the first definition variable to the second definition variable using the component function;
a third option data display unit, configured to display the option content in the moved third option data in the selection control of the original form item.

In some embodiments, the apparatus 700 for data display further includes:
a first option data movement module, configured to move the first option data from the second definition variable to the first definition variable using the component function.

In some embodiments, the first option data movement module includes:
a first option data storage unit, configured to store the first option data into an indefinite array according to the option identifier in the first option data;
an array length determining unit, configured to determine the length of the indefinite array by traversing the second definition variable;
a first option data movement unit, configured to move the first option data from the second definition variable to the first definition variable according to the length of the indefinite array.

In some embodiments, the apparatus 700 for data display further includes:
an option data movement module, configured to move the option data corresponding to the form item identifier in the option array according to the form item identifier included in the movement instruction when receiving the movement instruction for the form item;
a first option array updating module, configured to update the option array according to the moved option data;
a first option array display module, configured to display the updated option array on the user page.

In some embodiments, the apparatus 700 for data display further includes:
an option data deletion module, configured to delete the option data corresponding to the form item identifier in the option array according to the form item identifier included in the deletion instruction when receiving the deletion instruction for the form item;
a second option array updating module, configured to update the option array according to the deleted option data;
a second option array display module, configured to display the updated option array on the user page.

In some embodiments, the apparatus 700 for data display further includes:
a target sequence generation module, configured to sort the selected option data in the option array to generate the target sequence;
a target sequence display module, configured to output the target sequence to a terminal device for display to a user.

The specific details of each module in the above device for data display have been described in detail in the corresponding method for data display, so it will not be repeated here.

Each module in the above device can be a general-purpose processor, including a central processor, a network processor, etc. It can also be a digital signal processor, an application specific integrated circuit, a field programmable gate array or other programmable logic devices, discrete gates or transistor logic devices, and discrete hardware components. Each module can also be implemented in the form of software, firmware, etc. Each processor in the device can be an independent processor or integrated together.

The embodiments of the present disclosure also provide a computer-readable storage medium on which program products capable of realizing the methods described in the present description are stored. In some embodiments, various aspects of the present disclosure can also be implemented in the form of a program product, which includes program code. When the program product run on an electronic device, the program code is used to enable the electronic device to perform the steps described in the above “method for example” part of the description according to various embodiments of the present disclosure. The program product can adopt portable compact disc read-only memory (CD-ROM) and include program code, and can run on an electronic device, such as a personal computer. However, the program product of the present disclosure is not limited to this. In this document, the readable storage medium can be any tangible medium including or storing a program, and the program can be used by or in combination with an instruction execution system, component, or device.

The program product may employ any combination of one or more readable medium. The readable medium may be a readable signal medium or a readable storage medium. The readable storage medium may be, for example, but not limited to, an electrical, magnetic, optical, electromagnetic, infrared, or semiconductor system, device, or device, or any combination thereof. More specific examples (non-exhaustive list) of readable storage medium include: electrical connection with one or more wires, portable disk, hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the above.

The computer-readable signal medium may include data signals that are propagated in baseband or as part of a carrier wave, in which the readable program code is carried. Such propagated data signals may take various forms, including but not limited to electromagnetic signals, optical signals or any suitable combination of the above. The readable signal medium may also be any readable medium other than a readable storage medium, which may send, propagate, or transmit programs for use by or in combination with an instruction execution system, component, or device.

The program code included on the readable medium can be transmitted using any suitable medium, including but not limited to wireless, wired, optical cable, RF, etc., or any suitable combination of the above.

The program code for performing the operations of the present disclosure may be written in any combination of one or more programming languages, which include object-oriented programming languages such as Java, C++, and the like, as well as conventional procedural programming languages such as “C” or similar programming languages. The program code can be executed completely on the user computing device, partially on the user device, as an independent software package, partially on the user computing device, partially on the remote computing device, or completely on the remote computing device or server. In the case involving a remote computing device, the remote computing device may be connected to a user computing device through any kind of network, including a local area network (LAN) or a wide area network (WAN), or may be connected to an external computing device (for example, using an Internet service provider to connect via the Internet).

The embodiments of the present disclosure also provide an electronic device capable of realizing the above method. An electronic device 800 according to the embodiments of the present disclosure is described below with reference to FIG. 8. The electronic device 800 shown in FIG. 8 is only an example, and should not impose any restrictions on the functions and scope of use of the embodiments of the present disclosure.

As shown in FIG. 8, the electronic device 800 may be represented in the form of a general-purpose computing device. The components of the electronic device 800 may include, but are not limited to, at least one processing unit 810, at least one storage unit 820, a bus 830 connecting different system components (including storage unit 820 and processing unit 810), and a display unit 840.

The storage unit 820 stores program code, which can be executed by the processing unit 810, so that the processing unit 810 executes the steps described in the “method for example” part of the description according to various embodiments of the disclosure. For example, the processing unit 810 may perform any one or more of the method steps in FIG. 2, FIG. 4, and FIG. 5.

The storage unit 820 may include a readable medium in the form of a volatile storage unit, such as a random access storage unit (RAM) 821 and/or a cache storage unit 822, and may further include a read-only storage unit (ROM) 823.

The storage unit 820 may also include a program/utility 824 with a set (at least one) of program module 825, such program module 825 including, but not limited to, an operating system, one or more applications, other program modules, and program data. Each or some combination of these examples may include the implementation of a network environment.

The bus 830 may represent one or more types of bus structures, including a storage unit bus or a storage unit controller, a peripheral bus, a graphics acceleration port, a processing unit, or a local area bus using any bus structure in a variety of bus structures.

The electronic device 800 may also communicate with one or more external devices 900 (such as keyboards, pointing devices, Bluetooth devices, etc.), one or more devices that enable users to interact with the electronic device 800, and/or any device (such as routers, modems, etc.) that enables the electronic device 800 to communicate with one or more other computing devices. This communication can be performed via the input/output (I/O) interface 850. Furthermore, the electronic device 800 can also communicate with one or more networks (such as a local area network (LAN), a wide area network (WAN), and/or a public network, such as the Internet) through the network adapter 860. As shown, the network adapter 860 communicates with other modules of the electronic device 800 through the bus 830. It should be understood that although not shown in the drawing, other hardware and/or software modules can be used in combination with the electronic device 800, including but not limited to: microcode, device drivers, redundant processing units, external disk drive arrays, RAID systems, tape drives, data backup storage systems, etc.

Through the above description of the embodiments, it is easy for those skilled in the art to understand that the embodiments described here can be implemented by software or by combining software with necessary hardware. Therefore, the technical solution according to the embodiments of the present disclosure can be embodied in the form of a software product, which can be stored in a non-volatile storage medium (CD-ROM, USB flash disk, mobile hard disk, etc.) or on a network, and include a number of instructions to enable a computing device, which may be a personal computer, a server, a terminal device, or a network device, to execute a method according to some embodiments of the present disclosure.

In addition, the above drawings are only a schematic description of the process included in the method according to the embodiments of the present disclosure, not a limitation. It is easy to understand that the processes shown in the above drawings do not indicate or limit the chronological order of these processes. In addition, it is also easy to understand that these processes can be performed, for example, synchronously or asynchronously in multiple modules.

It should be noted that although several modules or units of the device for action execution are mentioned in the above detailed description, this division is not mandatory. In fact, according to the embodiments of the present disclosure, the features and functions of two or more modules or units described above can be embodied in one module or unit. On the contrary, the features and functions of a module or unit described above can be further divided into multiple modules or units for materialization.

It should be understood that the present disclosure is not limited to the precise structure already described above and shown in the drawings, and various modifications and changes can be made without departing from its scope. The scope of this disclosure is limited only by the appended claims.

1. A method for data display, comprising:
generating an original form item, wherein the original form item comprises a selection control, the selection control is associated with an option list, and the option list comprises an option data;
displaying, in response to receiving a selection operation for a first option data in the option list, the first option data on a user page;
removing the first option data from the option list and updating the option list; and
displaying, in response to receiving a selection operation for a second option data in the option list, the second option data on the user page.

2. The method for data display according to claim 1, wherein the method further comprises:
obtaining an option array of a selection box component, wherein the option array comprises an option identifier and an option content; and
assigning the option array to a first definition variable of the selection box component, wherein the first definition variable is used to store the option data to be selected.

3. The method for data display according to claim 2, wherein the generating the original form item comprises:
setting an attribute value of the selection box component to enable an option data in the option array to comprise both the option identifier and the option content;
setting an initial value of the option identifier; and
generating the original form item by rendering the user page according to the initial value of the option identifier, and displaying the option content in the selection control of the original form item.

4. The method for data display according to claim 3, wherein the displaying, in response to receiving the selection operation for the first option data in the option list, the first option data on the user page, comprises:
displaying the option content in the first option data in the selection control of the original form item.

5. The method for data display according to claim 4, wherein, the method further comprises:
triggering a component function used to listen to the selection control of the original form item and receiving the first option data passed in.

6. The method for data display according to claim 5, wherein the removing the first option data from the option list and updating the option list comprises:
moving the first option data from the first definition variable of the selection box component to a second definition variable of an option component using the component function, and updating the option list according to the first definition variable, wherein the second definition variable is used to store the option data being selected.

7. The method for data display according to claim 6, wherein the method further comprises:
adding, in response to receiving an adding instruction for a form item, an option data with an option identifier of null value in the option array; and
displaying the option data on the user page and generating a new form item.

8. The method for data display according to claim 7, wherein the displaying, in response to receiving the selection operation for the second option data in the option list, the second option data on the user page, comprises:
displaying, the option content in the second option data in a selection control of the new form item.

9. The method for data display according to claim 6, wherein the method further comprises:
triggering a component function used to listen to the selection control of the original form item in response to receiving a replacement operation for the first option data, and receiving a third option data passed in, wherein the third option data is stored in the first definition variable as the option data to be selected;
moving the third option data from the first definition variable to the second definition variable using the component function; and
displaying the option content in the third option data in the selection control of the original form item.

10. The method for data display according to claim 9, wherein the method further comprises:
moving the first option data from the second definition variable to the first definition variable using the component function.

11. The method for data display according to claim 10, wherein the moving the first option data from the second definition variable to the first definition variable using the component function comprises:
storing the first option data into an indefinite array according to the option identifier in the first option data;
determining a length of the indefinite array by traversing the second definition variable; and
moving the first option data from the second definition variable to the first definition variable according to the length of the indefinite array.

12. The method for data display according to claim 2, wherein the method further comprises:
moving, in response to receiving a movement instruction for a form item, according to a form item identifier included in the movement instruction, the option data in the option array corresponding to the form item identifier;
updating the option array according to the option data; and
displaying the option array on the user page.

13. The method for data display according to claim 2, wherein the method further comprises:
deleting, in response to receiving a deletion instruction for a form item, according to a form item identifier included in the deletion instruction, the option data in the option array corresponding to the form item identifier;
updating the option array according to the option data; and
displaying the option array on the user page.

14. The method for data display according to claim 2, wherein the method further comprises:
generating a target sequence by sorting the option data selected in the option array; and
outputting the target sequence to a terminal device.

15. (canceled)

16. A computer-readable storage medium with a computer program stored thereon, wherein the computer program is executed by a processor to implement a method for data display, comprising:
generating an original form item, wherein the original form item comprises a selection control, the selection control is associated with an option list, and the option list comprises an option data;
displaying, in response to receiving a selection operation for a first option data in the option list, the first option data on a user page;
removing the first option data from the option list and updating the option list; and
displaying, in response to receiving a selection operation for a second option data in the option list, the second option data on the user page.

17. An electronic device, comprising:
a processor; and
a memory, configured to store an executable instruction by the processor;
wherein, by executing the executable instruction, the processor is configured to:
generate an original form item, wherein the original form item comprises a selection control, the selection control is associated with an option list, and the option list comprises an option data;
display, in response to receiving a selection operation for a first option data in the option list, the first option data on a user page;
remove the first option data from the option list and updating the option list; and
display, in response to receiving a selection operation for a second option data in the option list, the second option data on the user page.

18. The electronic device according to claim 17, wherein the processor is further configured to:
obtain an option array of a selection box component, wherein the option array comprises an option identifier and an option content; and
assign the option array to a first definition variable of the selection box component, wherein the first definition variable is used to store the option data to be selected.

19. The electronic device according to claim 18, wherein the processor is further configured to:
move, in response to receiving a movement instruction for a form item, according to a form item identifier included in the movement instruction, the option data in the option array corresponding to the form item identifier;
update the option array according to the option data; and
displaying the option array on the user page.

20. The electronic device according to claim 18, wherein the processor is further configured to:
delete, in response to receiving a deletion instruction for a form item, according to a form item identifier included in the deletion instruction, the option data in the option array corresponding to the form item identifier;
update the option array according to the option data; and
display the option array on the user page.

21. The electronic device according to claim 18, wherein the processor is further configured to:
generate a target sequence by sorting the option data selected in the option array; and
output the target sequence to a terminal device.
